(19) United States
(12) Patent Application Publication
(10) Pub. No.: US 2013/0053007 A1
(43) Pub. Date: Feb. 28, 2013

(54) GESTURE-BASED INPUT MODE SELECTION FOR MOBILE DEVICES

(71) Applicants: Stephen Cosman, Redmond, WA (US); Aaron Woo, Redmond, WA (US); Jeffrey Cheng-Yao Fong, Seattle, WA (US)

(72) Inventors: Stephen Cosman, Redmond, WA (US); Aaron Woo, Redmond, WA (US); Jeffrey Cheng-Yao Fong, Seattle, WA (US)

(73) Assignee: Microsoft Corporation, Redmond, WA (US)

(21) Appl. No.: 13/216,567

(22) Filed: Aug. 24, 2011

(51) Int. Cl. H04W 88/02; H04W 4/18

(52) U.S. Cl. 455/414.3; 455/556.1

(57) ABSTRACT

Because of the small size and mobility of smart phones, and because they are typically hand-held, it is both natural and feasible to use hand, wrist, or arm gestures to communicate commands to the electronic device as if the device were an extension of the user's hand. Some user gestures are detectable by electro-mechanical motion sensors within the circuitry of the smart phone. The sensors can sense a user gesture by detecting a physical change associated with the device, such as motion of the device or a change in orientation. In response, a voice-based or image-based input mode can be triggered based on the gesture. Methods and devices disclosed provide a way to select from among different input modes to a device feature, such as a search, without reliance on manual selection.

### FIELD

This disclosure pertains to multi-modal user interfaces to electronic computing devices, and in particular, to the use of gestures to trigger different input modalities associated with functions implemented on a smart phone.

### BACKGROUND

“Smart phones” are mobile devices that combine wireless communication functions with various computer functions, for example, mapping and navigational functions using a GPS (global positioning system), wireless network access (e.g., electronic mail and Internet web browsing), digital imaging, digital audio playback, PDA (personal digital assistant) functions (e.g., synchronized calendaring), and the like. Smart phones are typically hand-held, but alternatively, they can have a larger form factor, for example, they may take the form of tablet computers, television set-top boxes, or other similar electronic devices capable of remote communication.

Motion detectors within smart phones include accelerometers, gyroscopes, and the like, some of which employ MEMS (micro-electro-mechanical) technology which allows mechanical components to be integrated with electrical components on a common substrate or chip. Working separately or together, these miniature motion sensors can detect phone motion or changes in the orientation of the smart phone, either within a plane (2-D) or in three dimensions. For example, some existing smart phones are programmed to rotate information shown on the display from a ‘portrait’ orientation to a ‘landscape’ orientation, or vice versa, in response to the user rotating the smart phone through a 90-degree angle. In addition, optical or infrared (thermal) sensors and proximity sensors can detect the presence of an object within a certain distance from the smart phone and can trigger receipt of signals or data input from the object, either passively or actively [U.S. Patent Publication 2010/0321289]. For example, using infrared sensors, a smart phone can be configured to scan bar codes or to receive signals from RFID (radio frequency identification) tags [Mantyjarvi et al., Mobile HCI Sep. 12-15, 2006].

A common feature of existing smart phones and other similar electronic devices is a search function that allows a user to enter text to search the device for specific words or phrases. Text can also be entered as input to a search engine to initiate a remote global network search. Because the search feature responds to input from a user, it is possible to enhance the feature by offering alternative input modes other than, or in addition to, text input that is “screen-based” i.e., an input mode that requires the user to communicate via the screen. For example, many smart phones are equipped with voice recognition capability that allows safe, hands-free operation, while driving a car. With voice recognition, it is possible to implement a hands-free search feature that responds to verbal input rather than written text input. A voice command, “Call building security” searches the smart phone for a telephone number for building security and initiates a call. Similarly, some smart phone applications, or “apps” combine voice recognition with a search function to recognize and identify music and return data to the user, such as a song title, performer, song lyrics, and the like. Another common feature of existing smart phones and other similar electronic devices is a digital camera function for capturing still images or recording live video images. With an on-board camera, it is possible to implement a search feature that responds to visual or optical input rather than written text input.

Existing devices that support such an enhanced search feature having different types of input modes (e.g., text input, voice input, and visual input) typically select from among different input modes by means of a button, touch screen entry, keypad, or via menu selection on the display. Thus, a search using voice input must be initiated manually instead of vocally, which means it is not truly a hands-free feature. For example, if the user is driving a car, the driver is forced to look away from the road and focus on a display screen in order to activate the so-called “hands-free” search feature.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Although the present disclosure is particularly suited to implementation on mobile devices, handheld devices, or smart phones, it applies to a variety of electronic devices and it is not limited to such implementations. Because the subject technology does not rely on remote communication, it can be implemented in electronic devices that may or may not include wireless or other communication technology. The terms “mobile device,” “handheld device,” “electronic device,” and “smart phone” are thus used interchangeably herein. Similarly, although the present disclosure is particularly concerned with a search feature, the gestural interface technology disclosed is not limited to such an implementation, but can also be implemented in conjunction with other device features or programs. Accordingly, the terms “feature,” “function,” “application,” and “program” are used interchangeably herein.

The methods and devices disclosed provide a way to trigger different input modes for a smart phone or similar mobile electronic device, without reliance on manual, screen-based selection. A mobile electronic device equipped with a detector and a plurality of input devices, can be programmed to accept input via the input devices according to different user input modes, and to select from among the different input modes based on a gesture. Non screen-based input devices can include a camera and a microphone. Because of the small size and mobility of smart phones, and because they are typically hand-held, it is both natural and feasible to use hand, wrist, or arm gestures to communicate commands to the electronic device as if the device were an extension of the user's hand. Some user gestures are detectable by electro-mechanical motion sensors within the circuitry of the smart phone. The sensors can sense a user gesture by detecting a physical change associated with the device, such as motion of the device itself or a change in orientation. In response, an input mode can be triggered based on the gesture, and a device feature, such as a search, can be launched based on the input received.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram illustrating an example mobile computing device in conjunction with which techniques and tools described herein can be implemented.

FIG. 2 is a general flow diagram illustrating a method of gesture-based input mode selection for a mobile device.

FIG. 3 is a block diagram illustrating an example software architecture for a search application configured with a gestural interface that senses hand and/or arm motion gestures, and in response, triggers various data input modes.

FIG. 4 is a flow diagram illustrating an advanced search method configured with a gestural interface.

FIG. 5 is a pictorial view of a smart phone configured with a search application that responds to a rotation gesture by listening for voice input.

FIG. 6 is a pair of snapshot frames illustrating a gestural interface, “Tilt to Talk.”

FIG. 7 is a sequence of snapshot frames (bottom) illustrating a gestural interface, “Point to Scan,” along with corresponding screen shots (top).

FIG. 8 is a detailed flow diagram of a method carried out by a mobile electronic device running an advanced search application that is configured with a gestural interface, according to representative examples described in FIGS. 5-7.

### DETAILED DESCRIPTION

### Example Mobile Computing Device

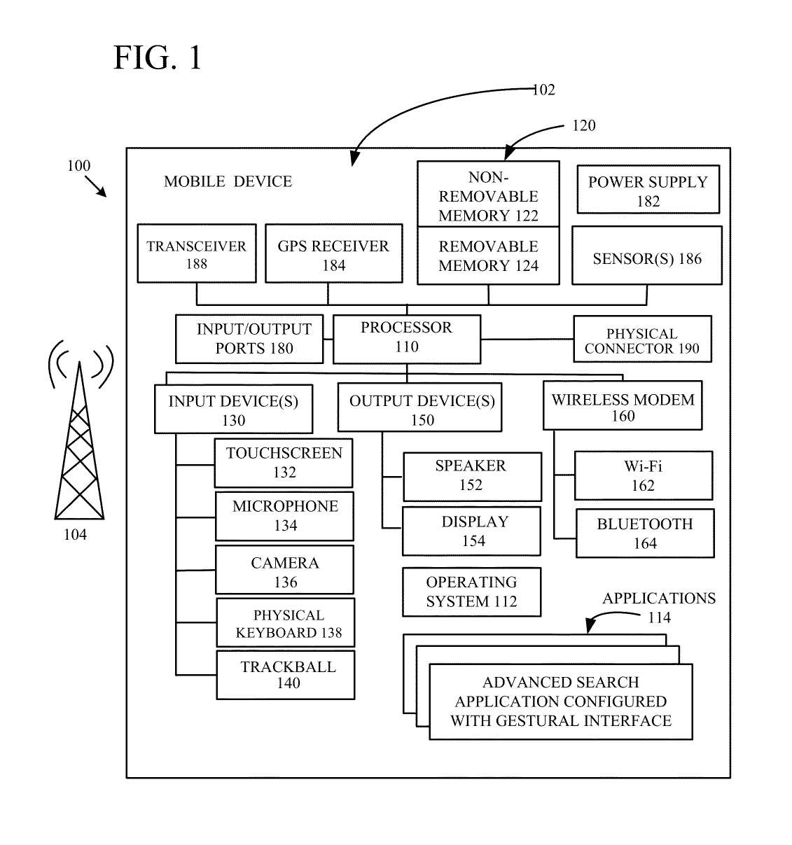

FIG. 1 depicts a detailed example of a mobile computing device (100) capable of implementing the techniques and solutions described herein. The mobile device (100) includes a variety of optional hardware and software components, shown generally at (102). In general, a component (102) in the mobile device can communicate with any other component of the device, although not all connections are shown, for ease of illustration. The mobile device can be any of a variety of computing devices (e.g., cell phone, smartphone, handheld computer, laptop computer, notebook computer, tablet device, netbook, media player, Personal Digital Assistant (PDA), camera, video camera, and the like), and can allow wireless two-way communications with one or more mobile communications networks (104), such as a Wi-Fi, cellular, or satellite network.

The illustrated mobile device (100) includes a controller or processor (110) (e.g., signal processor, microprocessor, ASIC, or other control and processing logic circuitry) for performing such tasks as signal coding, data processing, input/output processing, power control, and/or other functions. An operating system (112) controls the allocation and usage of the components (102) and support for one or more application programs (114), such as an advanced search application that implements one or more of the innovative features described herein. In addition to gestural interface software, the application programs can include common mobile computing applications (e.g., telephony applications, email applications, calendars, contact managers, web browsers, messaging applications), or any other computing application.

The illustrated mobile device (100) includes memory (120). Memory (120) can include non-removable memory (122) and/or removable memory (124). The non-removable memory (122) can include RAM, ROM, flash memory, a hard disk, or other well-known memory storage technologies. The removable memory (124) can include flash memory or a Subscriber Identity Module (SIM) card, which is well known in Global System for Mobile Communications (GSM) communication systems, or other well-known memory storage technologies, such as “smart cards.” The memory (120) can be used for storing data and/or code for running the operating system (112) and the applications (114). Example data can include web pages, text, images, sound files, video data, or other data sets to be sent to and/or received from one or more network servers or other devices via one or more wired or wireless networks. The memory (120) can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device (100) can support one or more input devices (130), such as a touch screen (132) (e.g., capable of capturing finger tap inputs, finger gesture inputs, or keystroke inputs for a virtual keyboard or keypad), microphone (134) (e.g., capable of capturing voice input), camera (136) (e.g., capable of capturing still pictures and/or video images), physical keyboard (138), buttons and/or trackball (140) and one or more output devices (150), such as a speaker (152) and a display (154). Other possible output devices (not shown) can include piezoelectric or other haptic output devices. Some devices can serve more than one input/output function. For example, touchscreen (132) and display (154) can be combined in a single input/output device.

The mobile computing device (100) can provide one or more natural user interfaces (NUIs). For example, the operating system (112) or applications (114) can comprise speech-recognition software as part of a voice user interface that allows a user to operate the device (100) via voice commands. For example, a user's voice commands can be used to provide input to a search tool.

A wireless modem (160) can be coupled to one or more antennas (not shown) and can support two-way communications between the processor (110) and external devices, as is well understood in the art. The modem (160) is shown generically and can include, for example, a cellular modem for communicating at long range with the mobile communication network (104), a Bluetooth-compatible modem (164), or a Wi-Fi-compatible modem (162) for communicating at short range with an external Bluetooth-equipped device or a local wireless data network or router. The wireless modem (160) is typically configured for communication with one or more cellular networks, such as a GSM network for data and voice communications within a single cellular network, between cellular networks, or between the mobile device and a public switched telephone network (PSTN).

The mobile device can further include at least one input/output port (180), a power supply (182), a satellite navigation system receiver (184), such as a Global Positioning System (GPS) receiver, sensors (186), such as, for example, an accelerometer, a gyroscope, or an infrared proximity sensor for detecting the orientation or motion of the device (100), and for receiving gesture commands as input, a transceiver (188) (for wirelessly transmitting analog or digital signals) and/or a physical connector (190), which can be a USB port, IEEE 1394 (FireWire) port, and/or RS-232 port. The illustrated components (102) are not required or all-inclusive, as any of the components shown can be deleted and other components can be added.

The sensors 186 can be provided as one or more MEMS devices. In some examples, a gyroscope senses phone motion, while an accelerometer senses orientation or changes in orientation. “Phone motion” generally refers to a physical change characterized by translation of the phone from one spatial location to another, involving change in momentum that is detectable by the gyroscope sensor. An accelerometer can be implemented using a ball-and-ring configuration wherein a ball, confined to roll within a circular ring, can sense angular displacement and/or changes in angular momentum of the mobile device, thereby indicating its orientation in 3-D.

The mobile device can determine location data that indicates the location of the mobile device based upon information received through the satellite navigation system receiver (184) (e.g., GPS receiver). Alternatively, the mobile device can determine location data that indicates the location of the mobile device in another way. For example, the location of the mobile device can be determined by triangulation between cell towers of a cellular network. Or, the location of the mobile device can be determined based upon the known locations of Wi-Fi routers in the vicinity of the mobile device. The location data can be updated every second or on some other basis, depending on implementation and/or user settings. Regardless of the source of location data, the mobile device can provide the location data to a map navigation tool for use in map navigation. For example, the map navigation tool periodically requests, or polls for, current location data through an interface exposed by the operating system (112) (which in turn can get updated location data from another component of the mobile device), or the operating system (112) pushes updated location data through a callback mechanism to any application (such as the advanced search application described herein) that has registered for such updates.

With the advanced search application and/or other software or hardware components, the mobile device (100) implements the technologies described herein. For example, the processor (110) can update a scene and/or list view, or execute a search in reaction to user input triggered by different gestures. As a client computing device, the mobile device (100) can send requests to a server computing device, and receive images, distances, directions, search results or other data in return from the server computing device.

Although FIG. 1 illustrates a mobile device in the form of a smart phone (100), more generally, the techniques and solutions described herein can be implemented with connected devices having other screen capabilities and device form factors, such as a tablet computer, a virtual reality device connected to a mobile or desktop computer, a gaming device connected to a television, and the like. Computing services (e.g., remote searching) can be provided locally or through a central service provider or a service provider connected via a network such as the Internet. Thus, the gestural interface techniques and solutions described herein can be implemented on a connected device such as a client computing device. Similarly, any of various centralized computing devices or service providers can perform the role of server computing device and deliver search results or other data to the connected devices

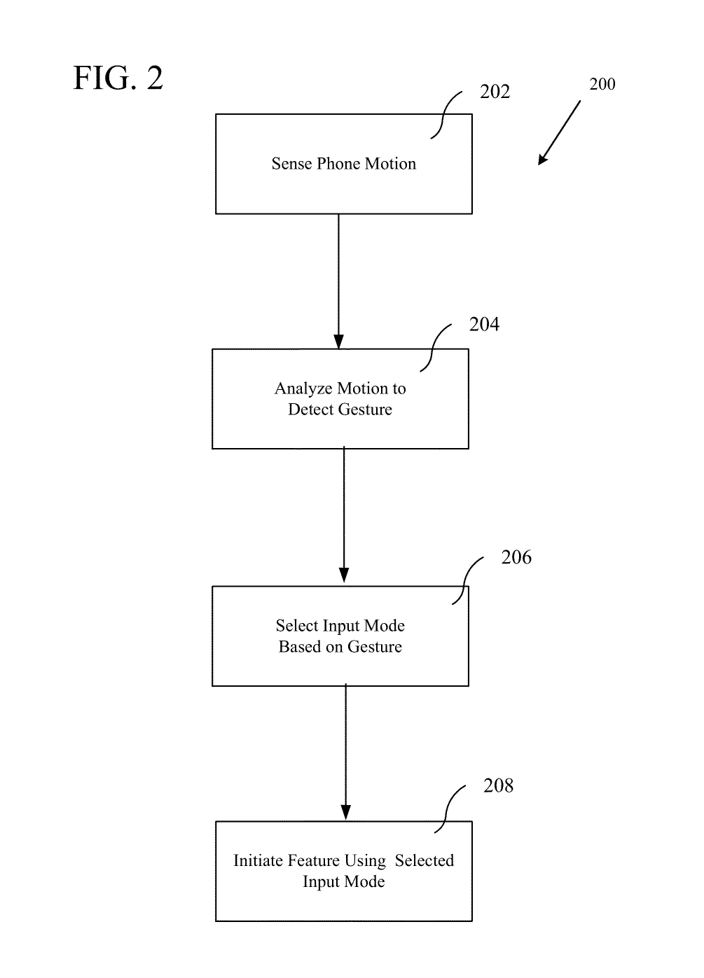

FIG. 2 shows a generalized method (200) of selecting an input mode to a mobile device in response to a gesture. The method (200) begins when phone motion is sensed (202) and interpreted to be a gesture (204) that involves a change in orientation or spatial location of the phone. When a particular gesture is identified, an input mode can be selected (206) and used to supply input data to one or more features of the mobile device (208). Features can include, for example, a search function, a phone calling function, or other functions of the mobile device that are capable of receiving commands and/or data using different input modes. Input modes can include, for example, voice input, image input, text input, or other sensory or environmental input modes.

Example Software Architecture for Selecting from Among Different Input Modes Using a Gestural Interface

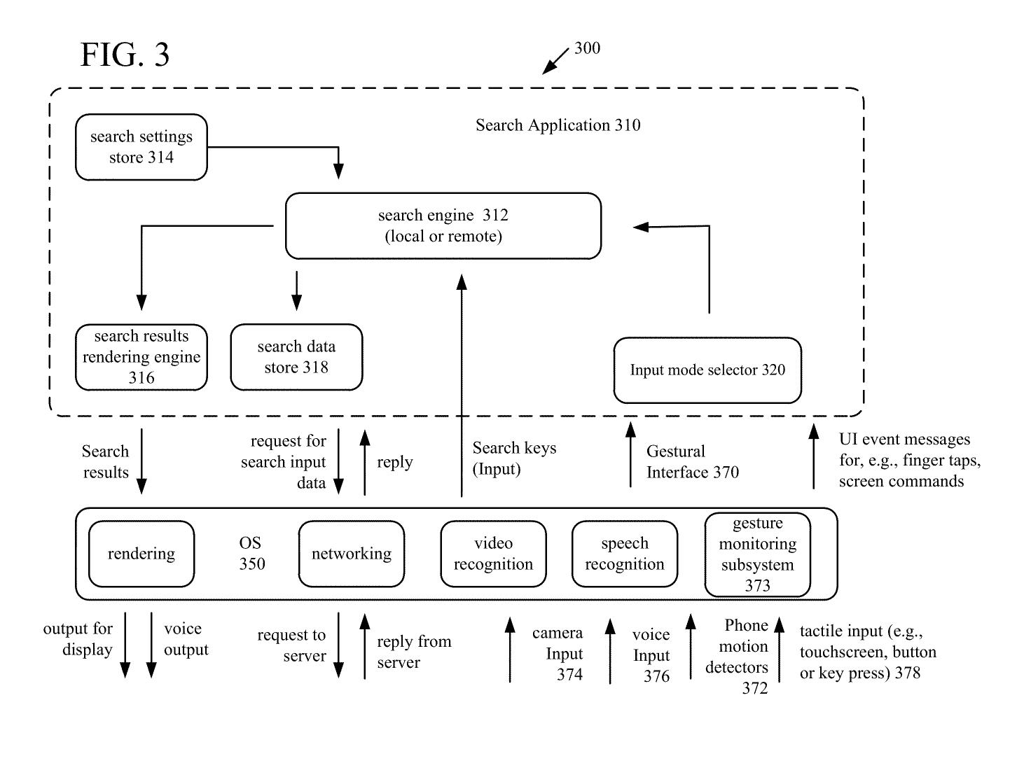

FIG. 3 shows an example software architecture (300) for an advanced search application (310) that is configured to detect user gestures and switch the mobile device (100) to one of multiple listening modes based on the user gesture detected. A client computing device (e.g., smart phone or other mobile computing device) can execute software organized according to the architecture (300) to interface with motion-sensing hardware, interpret sensed motions, associate different types of search input modes with the sensed motions, and execute one of several different search functions depending on the input mode.

The architecture (300) includes, as major components, a device operating system (OS) (350), and the exemplary advanced search application (310) that is configured with a gestural interface. In FIG. 3, the device OS (350) includes, among other components, components for rendering (e.g., rendering visual output to a display, generating voice output for a speaker), components for networking, components for components for video recognition, components for speech recognition, and a gesture monitoring subsystem (373). The device OS (350) is configured to manage user input functions, output functions, storage access functions, network communication functions, and other functions for the device. The device OS (350) provides access to such functions to the advanced search application (310).

The Advanced Search Application (310) can include major components, such as a search engine (312), a memory for storing search settings (314), a rendering engine (316) for rendering search results, a search data store (318) for storing search results and an input mode selector (320). The OS (350) is configured to transmit messages to the search application (310) in the form of input search keys that can be textual or image-based. The OS is further configured to receive search results from the search engine (312). The search engine (312) can be a remote (e.g., Internet-based), or a local search engine for searching information stored within the mobile device (100). The search engine (312) can store search results in the search data store (318) as well as outputting the search results using the rendering engine (316) for search results in the form of, for example, images, sound, or map data.

A user can generate user input to the advanced search application (310) via a conventional (e.g., screen-based) user interface (UI). Conventional user input can be in the form of finger motions, tactile input, such as touchscreen input, button presses or key presses, or audio (voice) input. The device OS (350) includes functionality for recognizing motions such as finger taps, finger swipes, and the like, for tactile input to a touchscreen, recognizing commands from voice input, button input or key press input, and creating messages that can be used by the advanced search application (310) or other software. UI event messages can indicate panning, flicking, dragging, tapping, or other finger motions on a touchscreen of the device, keystroke input, or another UI event (e.g., from voice input, directional buttons, trackball input, or the like).

Alternatively, a user can generate user input to the advanced search application (310) via a “gestural interface,” (370) in which case the advanced search application (310) has additional capability to sense phone motion using one or more phone motion detectors (372), and to recognize, via a gesture monitoring subsystem (373) non screen-based user wrist and arm gestures that change the 2-D or 3-D orientation of the mobile device (100). Gestures can be in the form of, for example, hand or arm movements, rotation of the mobile device, tilting the device, pointing the device, or otherwise changing its orientation or spatial position. The device OS (350) includes functionality for accepting sensor input to detect such gestures and for creating messages that can be used by the advanced search application (310) or other software. When such a gesture is sensed, a listening mode is triggered so that the mobile device (100) listens for further input. The input mode selector (320) of the advanced search application (310) can be programmed to listen for user input messages from the device OS (350), that can be received as camera input (374), voice input (376), or tactile input (378), and to select from among these input modes based on the sensed gesture, according to the various representative examples described below.

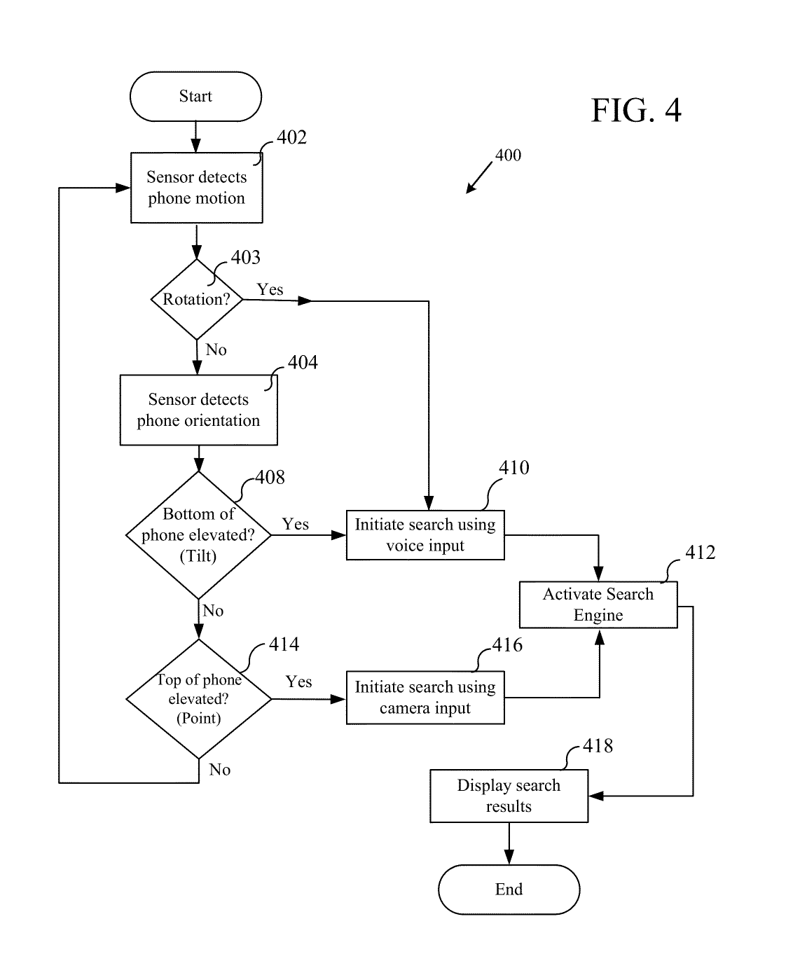

FIG. 4 illustrates an exemplary method for implementing an advanced search feature (400) on a smart phone configured with a gestural interface. The method (400) begins when one or more sensors detects phone motion (402), or a particular phone orientation (404). For example, if phone motion is detected by a gyroscope sensor, the motion is analyzed to confirm whether the motion is that of the smart phone itself such as a change in orientation, or a translation of the spatial location of the phone, as opposed to motions associated with a conventional screen-based user interface. When phone motion is detected (402), the gesture monitoring subsystem (373) interprets the sensed motion so as to recognize gestures that indicate the user's intended input mode. For example, if rotation of the phone is sensed (403), a search can be initiated using voice input (410).

Alternatively, if a particular orientation of the phone is sensed (404), or if a change in orientation is sensed, for example, by an accelerometer, the gesture monitoring subsystem (373) interprets the sensed orientation so as to recognize gestures that indicate the user's intended input mode. For example, if a tilt gesture is sensed, a search can be initiated using voice input, whereas if a pointing gesture is sensed, a search can be initiated using camera input. If the phone is switched on while it is already in a tilting or pointing orientation, even though the phone remains stationary, the gesture monitoring subsystem (373) can interpret the stationary orientation as a gesture and initiate a search using an associated input mode.

In the examples described in detail below, the smart phone can be configured with a microphone at the proximal end (bottom) of the phone and a camera lens at the distal end (top) of the phone. With such a configuration, detecting elevation of the bottom end of the phone (408) indicates the user's intention to initiate a search using voice input (410) to the search engine, (“Tilt to talk”) and detecting elevation of the top end of the phone (414) indicates the user's intention to initiate a search using camera images as input (416) to the search engine (“Point to scan”). Once the search engine has received the input the search engine is activated (412) to perform a search, and results of the search can be received and displayed on the screen of the smart phone (418). If a different type of phone motion is detected (402), the gestural interface can be programmed to execute a different feature other than a search.

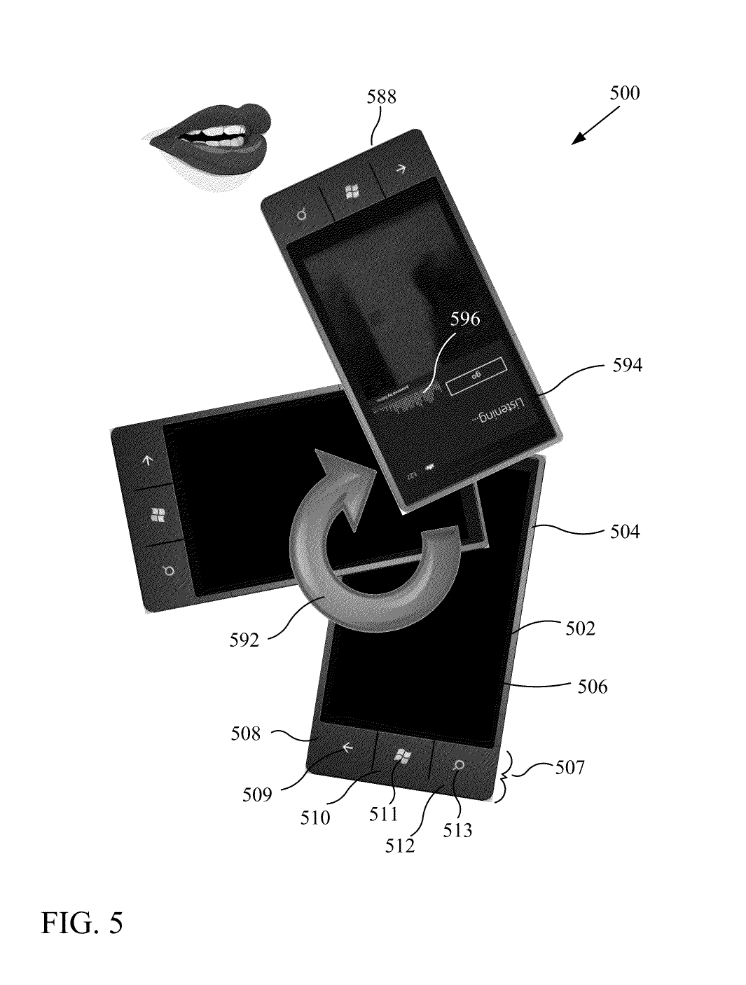

In FIG. 5, an exemplary mobile device (500) is shown as a smart phone having an upper surface (502) and a lower surface (504). The exemplary device (500) accepts user input commands primarily through a display (506) that extends across the upper surface (502). The display (506) can be touch-sensitive or otherwise configured so that it functions as an input device as well as an output device. The exemplary mobile device (500) contains internal motion sensors, and a microphone (588) that can be positioned near one end, and near the lower surface (504). The mobile device (500) can also be equipped with a camera having a camera lens that can be integrated into the lower surface (504). Other components and operation of the mobile device (500) generally conform to the description of the generic mobile device (100) above, including the internal sensors that are capable of detecting physical changes of the mobile device (500).

A designated area (507) of the upper surface (502) can be reserved for special-function device buttons (508), (510), and (512), configured for automatic, “quick access” to often-used functions of the mobile device (500). Alternatively, the device (500) includes more buttons, fewer buttons or no buttons. Buttons (508), (510), (512) can be implemented as touchscreen buttons that are physically similar to the rest of the touch-sensitive display (506), or the buttons (508), (510), (512) can be configured as mechanical push buttons that can move with respect to each other and with respect to the display (506).

Each button is programmed to initiate a certain built-in feature, or hard-wired application when activated. Application(s) to which the buttons (508), (510), (512) are associated can be symbolized by icons (509), (511), (513), respectively. For example, as shown in FIG. 4, the left hand button (508) is associated with a “back” or “previous screen” function symbolized by the left arrow icon (509). Activation of the “back” button initiates navigating the user interface of the device. The middle button (510) is associated with a “home” function symbolized by a magic carpet/Windows™ icon (511). Activation of the “home” button displays a home screen. The right hand button (512) is associated with a search feature symbolized by a magnifying glass icon (513). Activation of the search button (512) causes the mobile device (500) to start a search, for example within a Web browser at a search page, within a contacts application, or some other search menu, depending on the point at which the search button (512) is activated.

The gestural interface described herein is concerned with advancing capabilities of various search applications that are usually initiated by the search button (512), or otherwise require contact with the touch-sensitive display (506). As an alternative to activating a search application using the search button (512), activation can be initiated automatically, by one or more user gestures without the need to access the display (506). For example, an advanced search function scenario is depicted in FIG. 5 in which the mobile device (500) detects changes in its orientation via a gestural interface. Gestures detectable by sensors include two-dimensional and three-dimensional orientation-changing gestures, such as rotating the device, turning the device upside-down, tilting the device, or pointing with the device, each of which allows the user to command the device (500) by manipulating it, as if the device (500) were an extension of the user's hand or forearm. FIG. 5 further depicts what a user observes when a change in orientation is sensed, thereby invoking the gestural interface. According to the present example, when a user rotates the mobile device (500) in a clockwise direction as indicated by a right circular arrow (592), a listening mode (594) can be triggered. In response, the word “Listening . . . ” appears on the display (506), along with a graph (596) that serves as a visual indicator that the mobile device (500) is now in a voice recognition mode, awaiting spoken commands from the user. A signal displayed on the graph (596) fluctuates in response to ambient sounds detected by the microphone (588). Alternatively, a counter-clockwise rotation can trigger the voice input mode, or a different input mode.

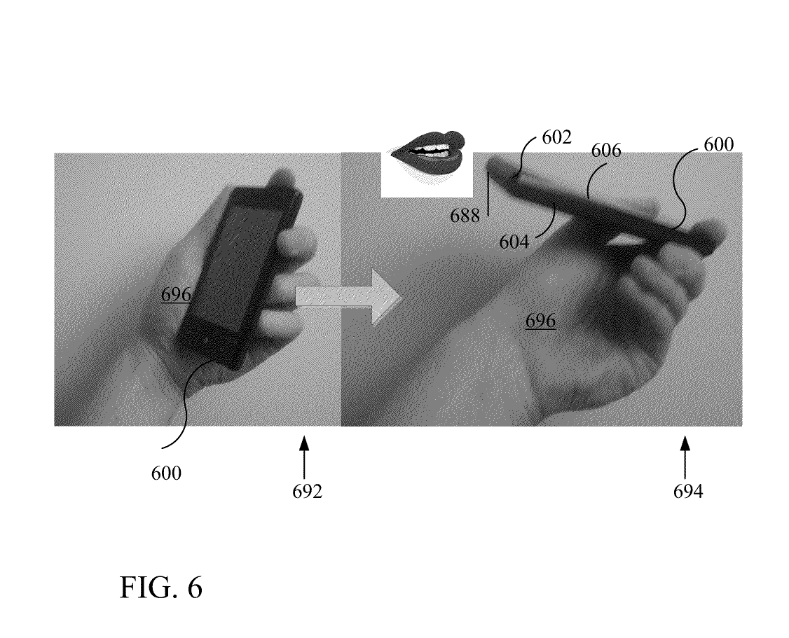

In FIG. 6, an exemplary mobile device (600) is shown as a smart phone having an upper surface (602) and a lower surface (604). The exemplary device (600) accepts user input commands primarily through a display (606) that extends across the upper surface (602). The display (602) can be touch-sensitive or otherwise configured so that it functions as an input device as well as an output device. The exemplary mobile device (600) contains internal sensors, and a microphone (688) positioned near the bottom, or proximal end, of the phone, and near the lower surface (604). The mobile device (600) can also be equipped with an internal camera having a camera lens that can be integrated into the lower surface (604) at the distal end (top) of the phone. Other components and operation of the mobile device (600) generally conform to the description of the generic mobile device (100) above, including the internal sensors that are capable of detecting changes in orientation of the mobile device (600).

The mobile device (600) appears in FIG. 6 in a pair of sequential snapshot frames, (692) and (694), to demonstrate another representative example of an advanced search application, this example referred to as “Tilt to Talk.” The mobile device (600) is shown in a user's hand (696), being held in a substantially vertical position at an initial time in the left hand snapshot frame (692) of FIG. 6, and in a tilted position at a later time, in the right hand snapshot frame (694) of FIG. 6. As the user's hand (696) tilts forward and downward, from the user's point of view, the orientation of the mobile device (600) from substantially vertical to substantially horizontal, exposing the microphone (688) located at the proximal end of the mobile device (600). Upon sensing that the proximal end (bottom) of the phone is elevated above the distal end (top) of the phone, thereby putting the phone in an “inverse tilt” orientation, the gestural interface triggers initiation of a search application wherein the input mode is voice input.

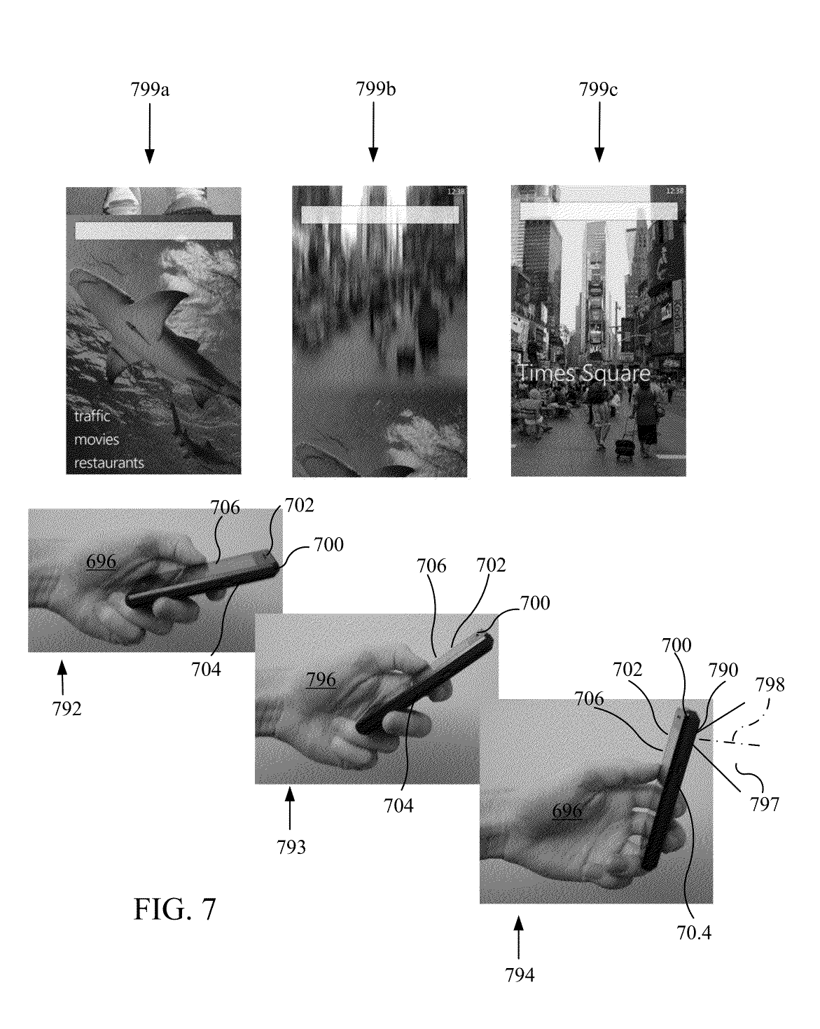

In FIG. 7, an exemplary mobile device (700) is shown as a smart phone having an upper surface (702) and a lower surface (704). The exemplary device (600) accepts user input commands primarily through a display (706) that extends across the upper surface (702). The display (706) can be touch-sensitive or otherwise configured so that it functions as an input device as well as an output device. The exemplary mobile device (700) contains internal sensors, and a microphone (788) positioned near the bottom, or proximal end, of the phone, and near the lower surface (704). The mobile device (700) can also be equipped with an internal camera having a camera lens (790) that is integrated into the lower surface (704) at the distal end (top) of the phone. Other components and operation of the mobile device (700) generally conform to the description of the generic mobile device (100) above, including the internal sensors, that are capable of detecting changes in orientation of the mobile device (700).

The mobile device (700) appears in FIG. 7 in a series of three sequential snapshot frames (792), (793), and (794), that demonstrate another representative example of an advanced search application, this example referred to as “Point to Scan.” The mobile device (700) is shown in a user's hand (796), being held in a substantially horizontal position at an initial time in the left hand snapshot frame (792) of FIG. 7; in a tilted position at an intermediate time in the middle snapshot frame (793); and in a substantially vertical position at a later time, in the right hand snapshot frame (794). Thus, as the user's hand (796) tilts backward and upward, from the user's point of view, the orientation of the mobile device (700) changes from a substantially horizontal position to a substantially vertical position, exposing the camera lens (770) located at the distal end of the mobile device (700). The camera lens (790) is situated so as to receive a cone of light (797) reflected from a scene, the cone (797) being generally symmetric about a lens axis (798) perpendicular to the lower surface (704). Thus, by pointing the mobile device (700), a user can aim the camera lens (790) and scan a particular target scene. Upon sensing a change in orientation of the mobile device (700) such that the distal end (top) of the phone is elevated above the proximal end (bottom) of the phone by a predetermined threshold angle, (which is consistent with a motion to point the camera lens (790) at a target scene) the gestural interface interprets such a motion as being a pointing gesture. The predetermined threshold angle can take on any desired value. Typically, values are somewhere in the range of between 45 and 90 degrees. The gestural interface then responds to the pointing gesture by triggering initiation of a camera-based search application wherein the input mode is a camera image, or a “scan” of the scene in the direction that the mobile device (700) is currently aimed. Alternatively, the gestural interface can respond to the pointing gesture by triggering initiation of a camera application, or another camera-related feature.

FIG. 7 further depicts what a user observes when a change in orientation is sensed, thereby invoking the gestural interface. At the top of FIG. 7, each of a series of three sequential screen shots (799a), (799b), (799c) show different scenes captured by the camera lens 7690) for display. The screen shots (699a), (799b), (799c) correspond to the sequence of device orientations shown in frames (792), (793), (794), respectively, below each screen shot. When the mobile device (700) is in the horizontal position, the camera lens (790) is aimed downward and the sensors have not yet detected a gesture. Therefore, the screen shot (799a) retains the scene (camera view) that was most recently displayed. (In the example shown in FIG. 7, the previous image is of the underside of sharks swimming at the ocean surface.) However, when the sensors detect a backward and upward motion of the user's hand (796), a camera mode is triggered. In response, a search function is activated, for which the camera lens (790) provides input data. The words “traffic” “movies” and “restaurants” then appear on the display (706) and the background scene is updated from the previous scene shown in screenshot (799a), to the current scene shown in screen shot (799b). Once the current scene comes into focus, as shown in frame (799c), an identification function can be invoked to identify landmarks within the scene and deduce the current location based on those landmarks. For example, using GPS mapping data, the identification function can deduce that the current location is Manhattan, and using a combination of GPS and image recognition of buildings, the location can be narrowed down to Times Square. A location name can then be shown on the display (706).

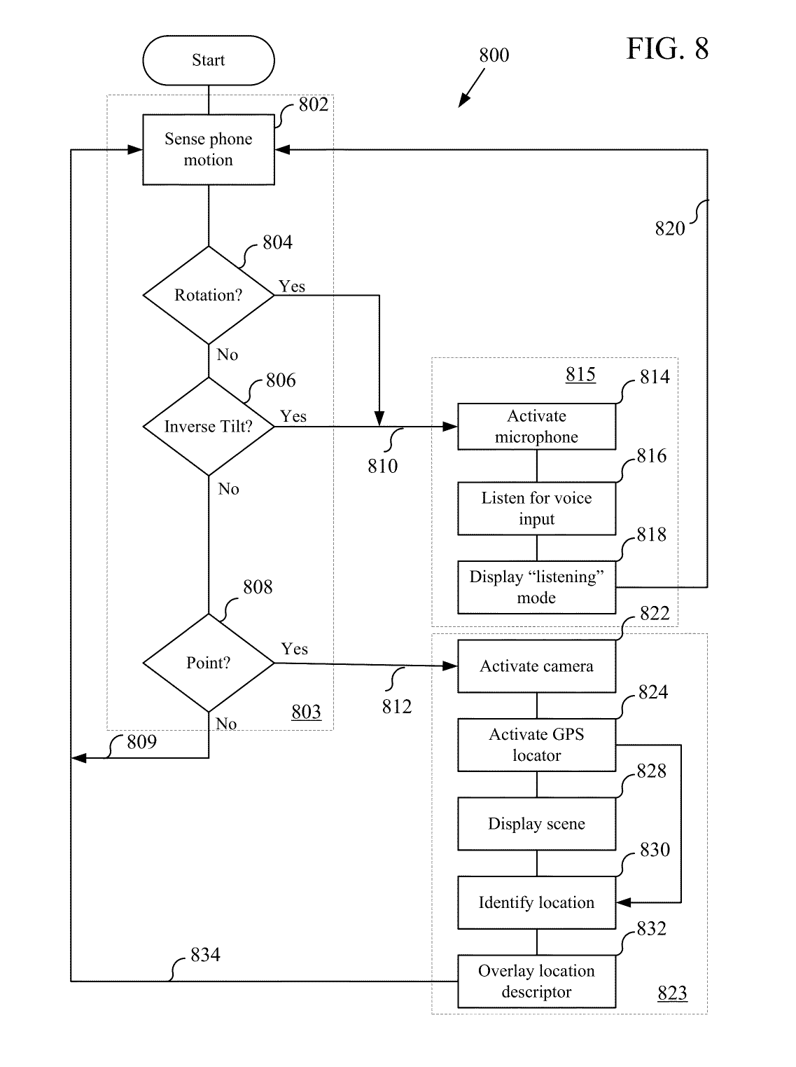

The advanced search application configured with a gestural interface (114) as described by way of the detailed examples in FIGS. 5-7 above, can execute a search method (800) shown in FIG. 8. Sensors within the mobile device sense phone motion (802) i.e., the sensors detect a physical change in the device, involving either motion of the device, a change in the device orientation, or both. Gestural interface software then interprets the motion (803) to recognize and identify a rotation gesture (804), an inverse tilt gesture (806), or a pointing gesture (808), or none of these. If none of the gestures (804), (806), or (808) is identified, sensors continue waiting for further input (809).

If a rotation gesture (804) or an inverse tilt gesture (806) is identified, the method triggers a search function (810) that uses a voice input mode (815) to receive spoken commands via a microphone (814). The mobile device is placed in a listening mode (816), wherein a message, such as “Listening.” can be displayed (818) while waiting for voice command input (816) to the search function. If voice input is received, the search function proceeds, using spoken words as search keys. Alternatively, detection of the rotation (804) and tilt (806) gestures that trigger voice input mode (815) can launch another device feature (e.g, a different program or function) instead of, or in addition to, the search function. Finally, control of the method (800) returns to motion detection (820).

If a pointing gesture is identified (808), the method (800) triggers a search function (812) that uses an image-based input mode (823) to receive image data via a camera (822). A scene can then be tracked by the camera lens for display (828) on the screen in real time. Meanwhile, a GPS locator can be activated (824) to search for location information pertaining to the scene. In addition, elements of the scene can be analyzed by image recognition software to further identify and characterize the immediate location (830) of the mobile device. Once the local scene is identified, information can be communicated to the user by overlaying location descriptors (832) on the screen shot of the scene. In addition, characteristics of, or additional elements in the local scene can be listed, such as, for example, businesses in the neighborhood, tourist attractions, and the like. Alternatively, detection of the pointing (808) gesture that triggers the camera-based input mode (823) can launch another device feature (e.g, a different program or function) instead of, or in addition to, the search function. Finally, control of the method (800) returns to motion detection (834).

Although the operations of some of the disclosed methods are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention can be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

1. A mobile phone comprising:
a phone motion detector;
a plurality of input devices;
a processor programmed to accept input from the input devices according to different input modes, and to activate an advanced search function having a gestural interface adapted to recognize and identify a user gesture by interpreting physical changes sensed by the phone motion detector,
wherein the gestural interface is configured to select from among different user input modes based on the gesture.

2. The mobile phone of claim 1, wherein the input devices comprise one or more of a camera or a microphone.

3. The mobile phone of claim 1, wherein the phone motion detector comprises sensors that include one or more of accelerometers, gyroscopes, proximity detectors, thermal detectors, optical detectors, or radio-frequency detectors.

4. The mobile phone of claim 1, wherein the user gesture is detectable as a change in the orientation of the mobile phone.

5. The mobile phone of claim 1, wherein the user gesture is detectable as a change in the motion of the mobile phone.

6. The mobile phone of claim 1, wherein the gesture is based partly on motion of the device and partly on orientation of the device.

7. The mobile phone of claim 1, wherein the input modes comprise one or more of image-based, sound-based, and text-based input modes.

8. A method of selecting from among different user input modes of an electronic device, the method comprising:
sensing phone motion;
analyzing the phone motion to detect a gesture;
selecting from among multiple input modes based on the gesture; and
initiating a feature based on information received via the input mode.

9. The method of claim 8, wherein sensing phone motion includes detecting an orientation of the device.

10. The method of claim 9, wherein detecting an orientation of the device includes recognizing that the device has been turned upside-down.

11. The method of claim 9, wherein detecting an orientation of the device includes recognizing that the device is substantially vertical.

12. The method of claim 8, wherein selecting from among multiple input modes includes selecting a camera-based input mode.

13. The method of claim 8, wherein selecting from among multiple input modes includes selecting a listening input mode that is capable of receiving voice commands.

14. The method of claim 8, wherein the feature is a search.

15. A method of selecting from among different user input modes to a search function for a mobile phone, the method comprising:
sensing phone motion;
in response to a rotation or an inverse tilt gesture, receiving voice input to the search function;
in response to a pointing gesture, receiving camera image input to the search function;
activating a search engine to perform a search; and
displaying search results.

16. The method of claim 15, wherein phone motion comprises one or more of a) a change in orientation of the device, or b) a change in location of the device.

17. The method of claim 15, wherein the inverse tilt gesture is characterized by elevation of a proximal end of the phone above a distal end.

18. The method of claim 15, wherein the pointing gesture is characterized by elevation of a distal end of the phone through a threshold angle above a proximal end.

19. The method of claim 15, wherein the search is performed locally on the mobile phone.

20. The method of claim 15, wherein the search is performed on a remote computing device.
